(19) United States
(12) Patent Application Publication
(10) Pub. No.: US 2004/0218164 A1
(43) Pub. Date: Nov. 4, 2004

(54) Exposure apparatus

(76) Inventor: Michio Kohno, Tochigi (JP)

Correspondence Address: MORGAN & FINNEGAN, L.L.P., 3 WORLD FINANCIAL CENTER, NEW YORK, NY, 10281-2101, US

(21) Appl. No.: 10/835,808

(22) Filed: Apr. 30, 2004

(30) Foreign Application Priority Data
May 1, 2003 (JP) 2003-126340

(51) Int. Cl. G03B 27/54

(52) U.S. Cl. 355/67; 355/69; 355/71; 355/53

(57) ABSTRACT

An exposure apparatus includes an illumination optical system for illuminating a reticle with light from a light source, a projection optical system for projecting a pattern of the reticle onto an object to be exposed, wherein the illumination optical system includes a light integrator that includes plural elements each having an arc section, wherein a secondary light source formed near an exit surface of the element can be accommodated in the exit surface of the element, and wherein a ratio of a chord to a width of the arc section of the element is between 2.0 and 18.0.

This application claims a benefit of foreign priority based on Japanese Patent Application No. 2003-126340, filed on May 1, 2003, which is hereby incorporated by reference herein in its entirety as if fully set force herein.

### BACKGROUND OF THE INVENTION

The present invention relates generally to an exposure apparatus, and more particularly to an exposure apparatus used in a lithography process to manufacture a semiconductor device, a liquid crystal display device, an imaging device, such as a CCD, a thin-film magnetic head, etc.

Recently, a manufacture of finer semiconductor devices has increased demands for high throughput with a design rule for a mass production line of 130 nm. The fine processing with improved resolution requires the uniform light intensity for illuminating a reticle or a mask and the uniform effective light-source distribution as an angular distribution of the exposure light for illuminating the reticle (or mask) as well as a shortened wavelength of exposure light and a higher numerical aperture (“NA”) of a projection lens.

Shortening the wavelength of exposure light can cause an increased absorption in an optical material, such as a glass material and optical coating, lowering the transmittance disadvantageously. Therefore, instead of a conventional dioptric projection optical system that includes only lenses, use of catoptric (i.e., full mirror type) and catadioptric (i.e., lens and mirror hybrid type) projection optical systems have been conventionally proposed. See, for example, Japanese Patent Applications Publication Nos. 62-115718 and 62-115719.

A projection optical system that uses a mirror usually shields the light near the optical axis, and the aberrational correction addresses only the off-axis image points. As a result, the exposure apparatus transfers a pattern by illuminating an off-axis effective imaging area. This effective imaging area is often rotationally symmetrical around the optical axis, and typically has an arc shape with a certain width.

To uniformly illuminate a reticle and to make an effective light-source distribution uniform, a conventional method proposes to combine an illumination optical system with a collimator lens and a light integrator that includes plural fine lenses or lens elements. The light integrator forms a secondary light source corresponding to the number of lens elements near the exit surface, and uniformly illuminate an object surface through superimpositions of beams from plural directions. The above exposure apparatus that uses an arc area for exposure can a light integrator that includes plural lens elements each having an arc-shaped section to uniformly illuminate the reticle through an arc illuminated area. See, for example, Japanese Patent Application Publication No. 62-115718.

A surface perpendicular to the optical axis of the lens element typically has an arc shape that is a similar figure to the illuminated area, since an incident surface of each lens element is conjugate with the reticle surface as the illuminated surface. The Helmholtz-Lagrange invariant (“HL amount”) invariant maintains a product So·θo constant, where So is an area of an exit surface of the lens element and θo is an exit angle. The product So·θo is usually defined by a screen size and the specification including NA.

Disadvantageously, the conventional illumination optical system cannot necessarily maintain high throughput: The HL amount is maintained between the incident and exit surfaces of the light integrator. Once the specification determines the HL amount from the image surface as discussed, a value of Si·θi as the HL amount from the light source is determined, where Si (=So) is an area of the incident surface of the lens element, and θi is an incident angle. When θi becomes larger than θo, a range that exceeds θo is shielded. In particular, where the fine processing relies upon an arc imaging area, the secondary light source suffers from shielding as the lens element has such a shape that a chord becomes relatively smaller than a height in the arc. One conceivable solution for this problem is to enlarge the height of the lens element. However, this increases areas for aberrational corrections and undesirably complicates a design of the projection optical system.

### BRIEF SUMMARY OF THE INVENTION

Accordingly, it is an exemplary object of the present invention to provide an exposure apparatus that improves a loss of light intensity in a light integrator and lowered throughput.

An exposure apparatus of one aspect according to the present invention includes an illumination optical system for illuminating a reticle that forms a pattern, with light from a light source, a projection optical system for projecting the pattern on the reticle onto an object to be exposed, wherein the illumination optical system includes a light integrator that includes plural elements each having an arc section, wherein a secondary light source formed near an exit surface of the element can be accommodated in the exit surface of the element, and wherein a ratio of a chord to a width of the arc section of the element is between 2.0 and 18.0. The ratio of the chord to the width of the arc section of the element may be between 3.0 and 10.0. The light from the light source may have a wavelength smaller than 20 nm, and the ratio of the chord to the width of the arc section of the element may be between 4.0 and 18.0.

An exposure apparatus of another aspect according to the present invention includes an illumination optical system for illuminating a reticle that forms a pattern, with light from a light source, a projection optical system for projecting the pattern on the reticle onto an object to be exposed, wherein the illumination optical system includes a first light integrator, and a second light integrator that includes plural elements, and forms a secondary light source using light from the first light integrator, wherein the secondary light source that is formed near an exit surface of the element can be accommodated in the exit surface of the element, and wherein the element has a rectangular section having a ratio of a width to a height between 2.0 and 18.0. The ratio of the width to the height of the rectangular section may be between 3.0 and 10.0.

An exposure apparatus of still another aspect according to the present invention includes an illumination optical system for illuminating a reticle that forms a pattern, with light from a light source, a projection optical system for projecting the pattern on the reticle onto an object to be exposed, wherein the illumination optical system includes a first light integrator that includes plural elements, and a zooming system for adjusting expanse of the light incident upon the first light integrator, and wherein the secondary light source that is formed near an exit surface of the element can be accommodated in the exit surface of the element, even when the size of the secondary light source varies as the expanse is adjusted.

The element may have a rectangular or arc section. The light from the light source may have a wavelength smaller than 20 nm. The exposure apparatus may further include a second light integrator that includes plural elements for uniformly illuminating the first light integrator.

The projection optical system may be a catoptric or catadioptric system. An optical axis of the illumination optical system may be offset from an optical axis from the light source to the first light integrator in the illumination optical system.

A device fabrication method of still another aspect according to the present invention includes the steps of exposing an object using an exposure apparatus, and developing the object that has been exposed. Claims for a device fabricating method for performing operations similar to that of the above exposure apparatus cover devices as intermediate and final products. Such devices include semiconductor chips like an LSI and VLSI, CCDs, LCDs, magnetic sensors, thin film magnetic heads, and the like.

Other objects and further features of the present invention will become readily apparent from the following description of the preferred embodiments with reference to accompanying drawings.

### BRIEF DESCRIPTION OF THE DRAWINGS

FIG. 1 shows a simplified optical path of an exposure apparatus of a first embodiment according to the present invention.

FIG. 2 is a view of arc imaging area by a projection optical system shown in FIG. 1.

FIG. 3 shows an optical path for explaining operations of decentering illumination area forming means shown in FIG. 1.

FIG. 4 is a plane view for explaining the way of cutting out a lens element at an incident side of a fly-eye lens shown in FIG. 1 from a spherical lens.

FIG. 5 is a side view for explaining the way of cutting out the lens element at the incident side of the fly-eye lens shown in FIG. 1 from the spherical lens.

FIG. 6 is a plane view of a layered structure at the incident side of the lens elements of the fly-eye lens shown in FIG. 1.

FIG. 7 is a plane view for explaining the way of cutting out a lens element at an exit side of a fly-eye lens shown in FIG. 1 from a spherical lens.

FIG. 8 is a side view for explaining the way of cutting out the lens element at the exit side of the fly-eye lens shown in FIG. 1 from the spherical lens.

FIG. 9 is a plane view of a layered structure at the exit side of the lens elements of the fly-eye lens shown in FIG. 1.

FIG. 10 is a plane view for explaining the lens element in a fly-eye lens shielding incident light.

FIG. 11 is a plane view for explaining the lens element in the fly-eye lens shown in FIG. 1 that does not shield the incident light.

FIG. 12 shows a simplified optical path of an exposure apparatus of a second embodiment according to the present invention.

FIG. 13 is a conceptual view of scanning exposure on a wafer shown in FIG. 1.

FIG. 14 is a view of a catoptric projection optical system.

FIG. 15 shows a simplified optical path of an exposure apparatus of the present invention.

FIG. 16 shows a simplified optical path in an illumination optical system in an exposure apparatus of a variation shown in FIG. 1.

FIG. 17 is a perspective view of an arrangement of a cylindrical fly-eye lens.

FIG. 18 shows a simplified optical path in an illumination optical system in an exposure apparatus of another variation shown in FIG. 1.

FIG. 19 is a flowchart for explaining a method for fabricating devices (semiconductor chips such as ICs, LSIs, and the like, LCDs, CCDs, etc.).

FIG. 20 is a detailed flowchart for Step 4 of wafer process shown in FIG. 19.

FIG. 21 is a view showing a catadioptric projection optical system.

FIG. 22 is a mirror type light integrator.

### DETAILED DESCRIPTION OF THE PREFERRED EMBODIMENTS

The instant inventor has analyzed a ratio of a width to a height in an effective exposure screen in a projection optical system that has a predetermined shape in the various photolithography fields that cover the semiconductor and the liquid crystal. The predetermined shape is a circle, an arc, a rectangle, etc. As a result, the instant inventor has numerically defined a range of an arc ratio, which does not shield the illumination light and is viable to a design of the projection optical system. A description will now be given of an exposure apparatus of the instant embodiment.

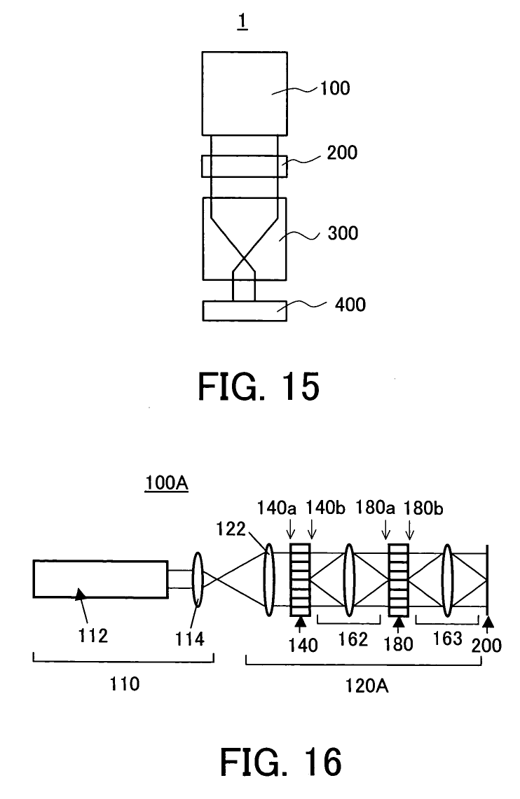

A detailed description will now be given of an exposure apparatus 1 of the instant embodiment, with reference to FIG. 15. The exposure apparatus 1 includes an illumination apparatus 100, a reticle 200, a projection optical system 300, and a plate 400.

The exposure apparatus 1 of this embodiment is a projection exposure apparatus that exposes a circuit pattern created on the reticle 200 in a step-and-scan manner onto the plate 400, but the present invention can apply a step-and-repeat manner and other modes of exposure method. The “step-and-scan” manner, as used herein, is one mode of exposure method that exposes a mask pattern onto the plate by continuously scanning the plate relative to the mask and by moving, after a shot of exposure, the plate stepwise to the next exposure area to be shot. The “step-and-repeat” manner is another mode of exposure method that moves the plate stepwise to an exposure area for the next shot every shot of cell projection onto the plate.

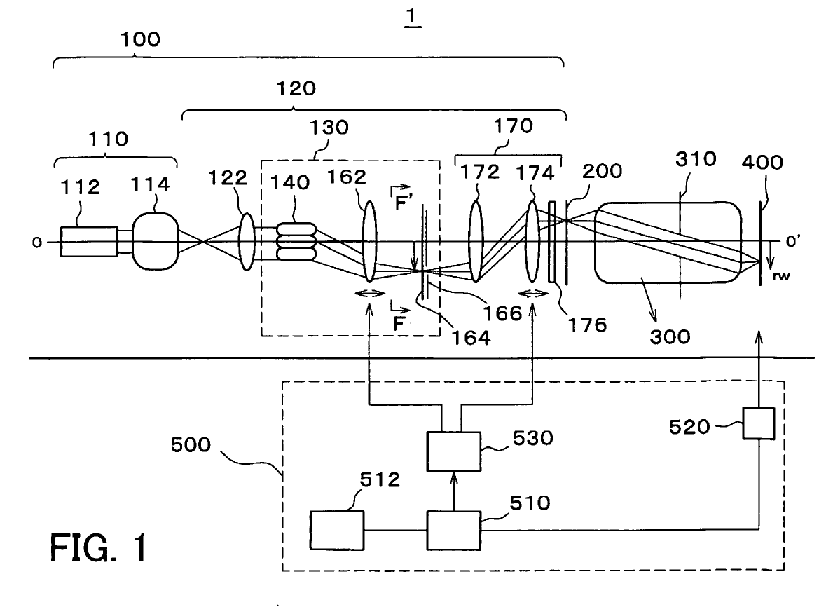

The illumination apparatus 100 illuminates the reticle 200 that forms a circuit pattern to be transferred with a uniform light intensity distribution and a uniform effective light source, and includes a light source part and an illumination optical system. FIG. 1 is a concrete example of the exposure apparatus 1 shown in FIG. 15. The illumination apparatus 100 includes a light source part 110 and an illumination optical system 120. The light source part 110 includes a light source 112 and a beam shaping optical system 114.

The light source 112 employs laser beams such as an ArF excimer laser with a wavelength of 193 nm, a KrF excimer laser with a wavelength of 24.8, an F₂ excimer laser with a wavelength of 157 nm, etc. in this embodiment. However, the present invention does not limit a type of laser to the excimer laser, and thus may use one or more ultra-high pressure mercury lamps, or xenon lamps. The light source part 110 may use an extreme ultraviolet (“EUV”) light source that emits EUV light (with a wavelength of 5 to 20 nm). Since no optical element transmits this light and the optical system should include only mirrors. Such an optical system can use any structure known in the art, and a detailed description of its structure and operation will be omitted.

The beam shaping system 114 may use, for example, a beam expander, etc., with a plurality of cylindrical lenses, and convert an aspect ratio of the size of the sectional shape of parallel beams from the laser light source into a desired value (for example, by changing the sectional shape from a rectangle to a square), thus reshaping the beam shape to a desired one. The beam shaping system 114 forms a beam that has a size and divergent angle necessary for illuminating an optical integrator 140 described later.

Preferably, the light source part uses an incoherently turning optical system, though it is not shown in FIG. 1, which turns a coherent laser beam into an incoherent one. The incoherently turning optical system may use, for example, at least one return system that splits an incident beam into at least two beams (e.g., p polarized light and s polarized light) at a light splitting plane, provides one of them, relative to the other beam, with an optical path length difference more than the coherence length of a laser beam via an optical member, and then leads it to the light splitting plane again so that the superimposed light is emitted.

The illumination optical system 120 includes a first condenser lens 122, a decentering illumination area forming part 130, and a masking imaging system 170. The first condenser lens 122 arranges an imaging surface of the beam shaping system 114 and an incident surface in a fly-eye lens 140, which will be described later, in the decentering illumination area forming part 130 in a Fourier transformation relationship. In the instant application, the Fourier transformation relationship means an optical relationship between a pupil plane and an object plane (or an image plane) or an object plane (or an image plane) and a pupil plane. If necessary, the beam shaping system 114 may include deflecting mirrors between the beam shaping system 114 and the first condenser lens 122.

The fly-eye lens 140, which will be described later is located at a rear focal point of the first condenser lens 122, forming a telecentric optical system on its exit side. When the telecentric optical system is formed on the exit side, the principal ray of light that has passed through the lens 122 becomes parallel to any of central and peripheral lens elements 142 in the fly-eye lens 140.

When the telecentric optical system is not formed on the exit side of the first condenser lens 122 and the center lens element 142 in the fly-eye lens 140 has approximately the same NA (i.e., not-shielding NA) as that of the incident light, the peripheral lens elements 142 identical to the central lens element 142 shield the incident light because the principal ray inclines. In order to prevent the light incident upon the fly-eye lens 140 from being shielded by each lens element 142, the peripheral lens elements 142 should have higher NA than the central lens element by an inclination of the incident principal ray.

However, the fly-eye lens 140 has a continuously layered structure without a gap, as described later with reference to FIGS. 6 to 9, and thus diameters of respective lens elements 142 cannot be optimized. Therefore, the central lens element 142 and the peripheral lens elements 142 should be identical for the closest packing arrangement. The telecentric optical system at the exit side of the first condenser lens 122 would enable all the lens elements 142 in the fly-eye lens 140 to share the not-shielding minimum NA of the central lens element 142.

Preferably, this first condenser lens 122 is used as a zooming system, because a size of the secondary light source formed near the exit surface of the fly-eye lens 140 becomes variable. This mechanism can prevent a loss of the light intensity and thus is suitable for a variable illumination mode in the illumination optical system.

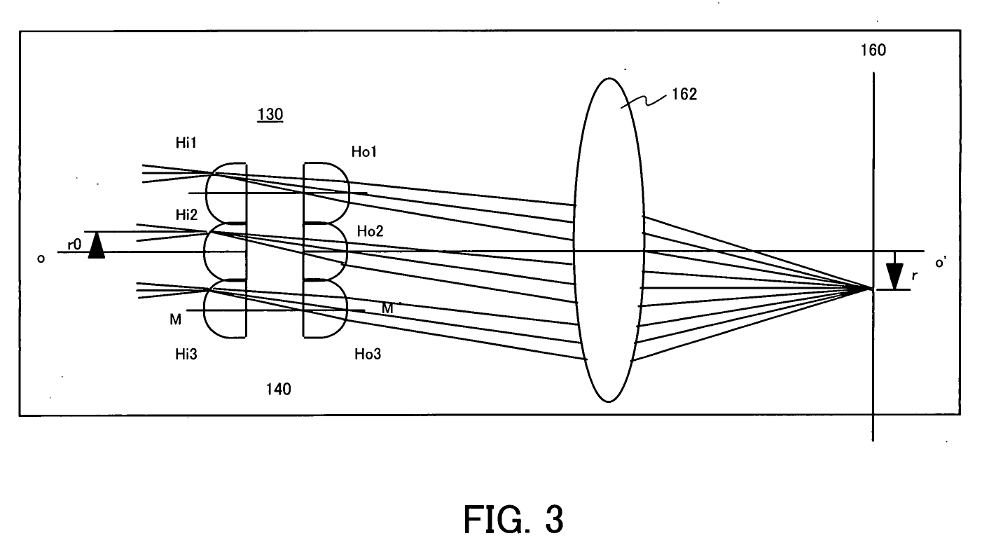

The decentering illumination area forming part 130 serves to form the off-axis illumination light that offsets from the optical axis OO′, and includes the fly-eye lens 140, a second condenser lens 162, a first illuminated surface 164, and a slit 166. FIG. 3 shows a typical optical path when the decentering illumination area forming part 130 shown in FIG. 1 forms the off-axis illumination light.

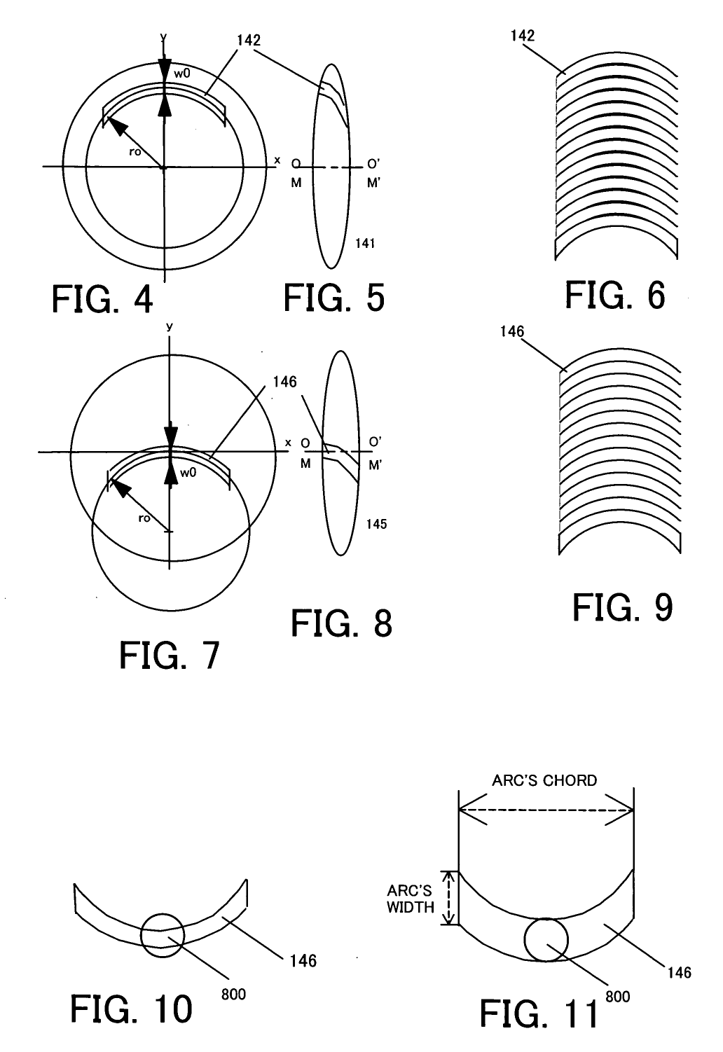

The fly-eye lens 140 is one type of a light integrator for converting an angular distribution of the incident light into a positional distribution and then emits the light. The fly-eye lens 140 has, as shown in FIG. 4, a shape that cuts out an arc with a predetermined width, i.e., light transmission part in FIG. 3, from a semicircle, and layers plural (fourteen in the instant embodiment) arcs. The fly-eye lens 140 includes an incident lens element 142 and an exit lens element 146 spaced by a focal distance f. Since a pair of the incident and exit lens elements 142 and 146 are spaced by a focal distance f, the incident and exit surfaces have a Fourier transformation relationship. The incident and exit lens elements 142 and 146 are similar to the effective imaging area on the projection optical system 300 or the illuminated area on the plate 400: The condenser lens 162 arranges the incident surface of the incident lens 142 and the first illuminated surface 164 in an optically conjugate relationship, as clarified from FIG. 3. The slit surface 166 near the illuminated surface 164 is conjugate, as shown in FIG. 1, with the reticle surface due to the masking imaging system 170. Finally, the projection optical system 300 makes these conjugate surfaces conjugate with the plate 400 surface. When the sectional shapes of the incident and exit lens elements 142 and 146 are made similar to a shape of the illuminated area on the plate 400, the arc illumination area is directly formed on the plate 400 surface in appearance. This is a requirement for effective arc illuminations.

However, only this cannot expect the light from the light source incident upon the fly-eye lens 140 to pass through the fly-eye lens 140 without being shielded. A description will now be given of the reason and a condition to enable the light to effectively pass through the fly-eye lens.

A description will now be given of an arc-shaped structure of the fly-eye lens. FIG. 4 is a plane view for explaining the way of cutting out the incident lens element 142 as an effective area from an incident lens 141. FIG. 5 is a side view of the incident lens 141 shown in FIG. 4. FIG. 6 is a plane view of the incident lenses 143 formed by layering fourteen incident lens elements 142. FIG. 7 is a plane view for explaining the way of cutting out the exit lens element 146 as an effective area from an exit lens 145. FIG. 8 is a side view of the exit lens 145 shown in FIG. 7. FIG. 9 is a plane view of the incident lenses 147 formed by layering fourteen exit lens elements 146.

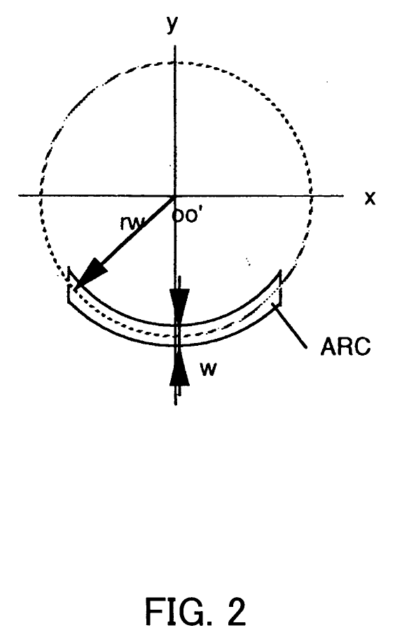

Referring to FIGS. 4 to 7, the incident lens element 142 has a similar figure to an arc exposure area ARC on a surface of the plate 400, which will be described with reference to FIG. 2. The incident lens 141 shown in FIG. 5 and the exit lens 145 shown in FIG. 8 have the same spherical lens, but a cutting position on the incident and exit lenses 145 is different between the incident and exit lens elements 142 and 146. This is because the light that has passes through the incident lens element 142 is deflected onto the axis, as shown in FIG. 3. FIG. 3 is a detailed view of the decentering illumination area forming means 130 shown in FIG. 1. The fly-eye lens 140 includes incident lens group 143 that includes plural exemplary lens elements 142, and exit lens group 147 that includes plural exemplary lens elements 146, and both lens groups 143 and 147 are spaced by the focal distance f.

If necessary, a stop (not shown) is provided near the exit surface of the fly-eye lens 140. The stop is a variable aperture stop that shields unnecessary light to form a desired shape of a secondary light source, and various stops are available such as a circular aperture stop and a stop for annular illumination. A modified illumination is available with an aperture stops that has an annular or quadrupole opening. The modified illumination method or oblique incidence illumination method that uses such an aperture stop can extend the limits of the resolving power. The replacement of the variable aperture stop may use, for example, a disc turret that forms these aperture stops, and a controller and a drive mechanism (not shown) turns the turret to switch the opening. Such an aperture stop can vary an illumination mode.

A description will now be given of an angular distribution of the light incident upon the fly-eye lens 140. The distribution of light incident upon the fly-eye lens is generally rotationally symmetrical around the optical axis or rectangle. This can be naturally concluded from a fact that the light source 112 uses, for example, an elliptic mirror to condense rotationally symmetrical light, or a laser with a rectangular beam sectional shape, and a rotationally symmetrical optical element, such as a lens, to introduce the light from these light sources. As suggested in FIG. 3, the incident light distribution upon the incident lens elements 142 is projected onto the exit lens elements 146. The light intensity distribution is rotationally symmetrical, such as a circle, or a rectangle.

FIG. 10 shows a light intensity distribution on the exit lens elements 146. A circle 800 indicates the light intensity distribution incident upon the fly-eye lens. Only the light inside the arc effective area of the exit lens element 146 passes through the fly-eye lens 140 and reaches the plate 400 surface. A size of the circle, or an angular distribution of the light incident upon the fly-eye lens is an amount uniquely determined by the sectional area and luminescent color of the light emitted from the light source, and a sectional area of the fly-eye lens 140. This amount is called a Helmholtz-Lagrange invariant (“HL amount”).

On the other hand, a size of the arc exit lens element 146, in particular, an arc width depends upon the image point width after sufficient aberrational correction has conducted for the projection optical system, and is uniquely determined by the above imaging relationship. In other words, once the light source and the effective screen size of the projection optical system 300 are determined, they determine the light transmittance in the fly-eye lens (or light use efficiency). As a result of that the instant inventor has studied designs of projection optical system 300 having various arc effective imaging areas based on this optical design principle, and researched physical amounts of the light source, such as luminous sectional area and luminescent color, the instant inventor has discovered that the above light shielding does not occur when the following condition is met. FIG. 11 shows such a state of light.

A shape of the lens element 146 is made arc in accordance with the arc exposure area. In order for the secondary light source formed near the exit surface of the lens element 146 in the fly-eye lens 140 to have a size that can be accommodated in the exit surface of the lens element 146, a ratio of the chord to the width in the arc in the lens element 146, i.e., an arc ratio, is preferably between 2.0 and 18.0, more preferably between 3.0 and 10.0. This range advantageously prevents shielding and reduces necessary aberrational corrections. The lower limit of 2.0 relies upon experience that the aberrational correction for the projection optical system has the limits, and the arc effective imaging area thicker than this value is difficult in view of a design. The upper limit of 18.0 is a condition that the fly-eye lens 140 shields the light with a thin arc screen as shown in FIG. 10. FIG. 11 shows an “arc's width” and an “arc's chord”.

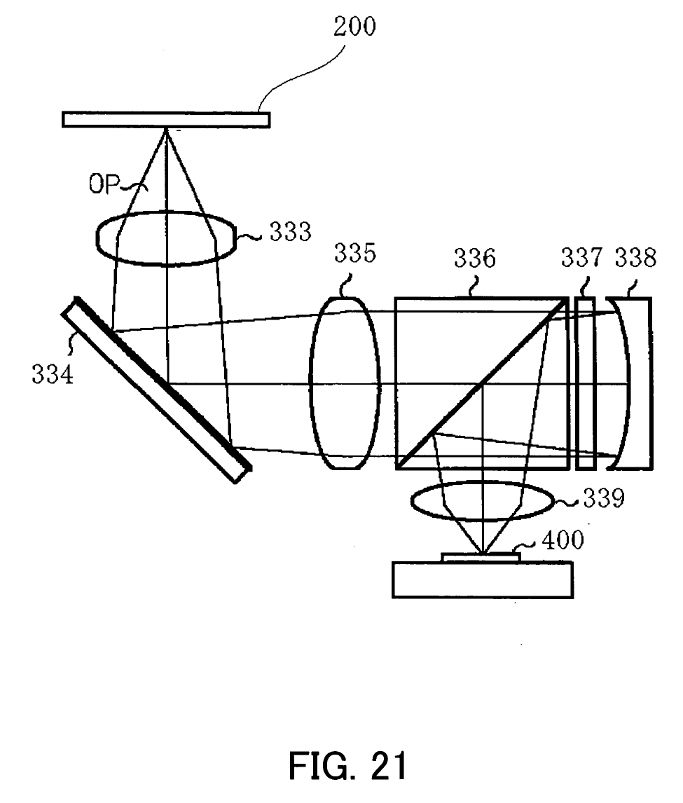

As a concrete numerical example, one shot screen in a scanning exposure apparatus for semiconductor exposure conceivably has a size of 22 mm×30 mm or 26 mm×33 mm. The designed screen size of the projection optical system is arc length 22 mm×arc width 7 mm in the former case, and arc length 26 mm×arc width 5 mm in the latter case. The arc ratio in these cases area 3.1 and 5.2. The projection optical system that implements these designs would be a catadioptric system shown in FIG. 21, and the light source would be an excimer laser.

In the catadioptric projection optical system shown in FIG. 21, the light OP from the reticle 200, which has information of a pattern on the reticle 200 is condensed by a lens system 333, reflected by a mirror 334, and condensed by the lens system 335. Only the predetermined polarized light component passes through a polarizing beam splitter 336, and is introduced to a concave mirror 338 via a λ/4 plate 337. The light OP that has reflected on the concave mirror 338 is passes through the λ/4 plate 337 again. Thereby, the light OP has a polarization direction rotated by 90° relative to the polarization direction in which the light OP passes through the polarizing beam splitter 336. Therefore, the light OP is reflected on the polarizing beam splitter 336, and projects the pattern on the reticle 200 onto the plate 400 via the lens system 339. FIG. 21 is a view of the catadioptric projection optical system.

When the light source 112 is the EUV light source, a ratio of the chord to the height in the exposure area is empirically between 4.5 and 18.0. The lower limit becomes larger than the previous example, because the exposure apparatus uses the EUV light with a very small wavelength between 5 nm and 20 nm as exposure light, and makes the projection optical system of four to six mirrors. Therefore, it is difficult to maintain a wide effective imaging area.

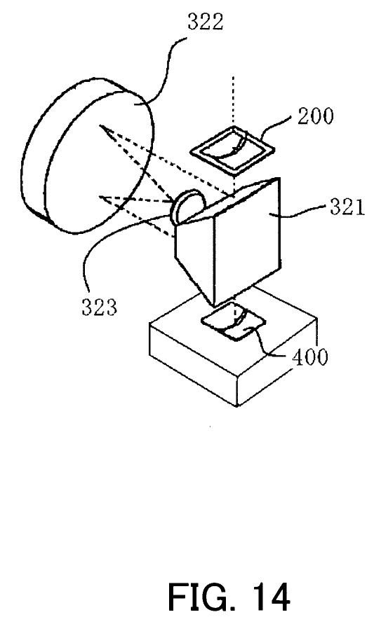

Another numerical example is an optical system for exposing a liquid crystal plate. In this case, the projection optical system can use a type shown in FIG. 14, and the light source can use an ultra-high pressure mercury lamp. In FIG. 14, 321 is a trapezoid mirror, and 322 and 333 are concave mirrors, introducing the light from a pattern on the reticle 200 to the plate 400. FIG. 14 is a view of a catoptric projection optical system. This exposure apparatus exposes a large plate, such as a width of 400 mm and a length of 600 mm through one scan. The screen size is assumed to have an arc length of about 400 mm and an arc width of about 42 mm, and the arc ratio is 9.5 in this case. If necessary, provided on the first illuminated surface 164 can be a width variable slit for uniform light intensity, a masking blade for restricting an exposure area, etc. as shown in FIG. 1.

The slit 166 has an arc light transmitting part and a light shielding part on a uniformly illuminated area by the second condenser lens 162. The light that has passes through the light transmitting part in the slit 166 is used as illumination light for the reticle 200. The slit 166 is provided on a focal plane of the second condenser lens 162, and maintains the telecentric optical system.

The masking imaging optical system 170 serves to re-image an aperture image of the slit 166 on the reticle 200, and includes a first lens system 172, a second lens system 174, and a correction member 176. The lens systems 172 and 174 include plural lenses. If necessary, deflecting mirrors may be inserted between the lens systems 172 and 174. The instant embodiment makes the second lens system 174 movable along the optical axis OO′, and drivable by a driver 530 in a control system 500. The correction member 176 corrects an offset of telecentricity of the off-axis light, i.e., an offset angle between the principal ray and the optical axis OO′, and includes a normal spherical lens that is movable in the co-axial direction and an aspheric lens with positive or negative power.

The control system 500 includes a controller 510, a memory 512, a detector 520, and a driver 530. In the relationship with the present invention, the controller 510 detects, through the detector 520, an offset of the telecentricity of the light incident upon the projection optical system 300, which will be described later, i.e., an offset angle between the principal ray and the optical axis OO′, and controls the driver 530 to remove the offset by moving the second condenser lens 162 and/or the second lens system 174 along the optical axis OO′.

The controller 510 is connected to the detector 520, and can control positions of the second condenser lens 162 and the second lens system 174 independently based on the detection result by the detector 520. The controller 510 is connected to the memory 512, the memory stores a telecentricity control method conducted by the controller 510 and/or data used for it in the relationship with the present invention. The memory 512 includes, for example, a ROM, a RAM, and another storage. In the instant embodiment, the controller 510 is a controller for the illumination apparatus 100, but may serve as a controller of the exposure apparatus 1 or a controller of an external apparatus, if necessary. The controller 510 may further control the exposure apparatus 1 or the external apparatus. If necessary, the memory 512 and the detector 530 may be provided outside the illumination apparatus 100.

The detector 520 includes, for example, a pinhole and a two-dimensional sensor arranged near the plate 400. The pinhole 520 is arranged at a position conjugate with the reticle 200, and the two-dimensional sensor is arranged below the pinhole so that its light-receiving surface is located at a position apart from the pinhole by a certain distance h. When the two-dimensional sensor observes illumination light emitted from the illumination optical system 120 through a pinhole and a stop (or entrance pupil) 310 of the projection optical system 300, the light-intensity distribution of a stop 310 can be measured. The detector 520 calculates the offset amount of the telecentricity as an offset between the center of the stop 310 and the center of the illumination light based on this light intensity distribution.

The reticle 200 forms a circuit pattern (or an image) to be transferred. Diffracted light emitted from the reticle 200 passes through the projection optical system 300, and then is projected onto the plate 400. The plate 400 is an object to be exposed, onto which resist is applied. The slit 166 and the reticle 200 are arranged in a conjugate relationship. A light exit surface of the fly-eye lens 140 and the reticle 200 have a Fourier transformation relationship. The mask 200 and the plate 400 have a conjugate relationship.

In case of a scanning exposure apparatus, a pattern on the reticle 200 is transferred onto the plate 400 by scanning the reticle 200 and the plate 400.

The projection optical system 300 images the light from the pattern formed on the reticle 200 onto, and uses a catadioptric optical system that includes plural lens elements and at least one concave mirror. However, the projection optical system 300 applicable to the present invention covers a catoptric optical system, a special lens type, and so on. Any necessary correction of the chromatic aberration may use a plurality of lens units made from glass materials having different dispersion values (Abbe values), or arrange a diffractive optical element such that it disperses in a direction opposite to that of the lens unit. The projection optical system has the stop 310, and telecentrically images the off-axis light that represents the circuit pattern on the reticle 200 onto the plate 400. The optical axis OO′ in the projection optical system 300 accords with the optical axis OO′ in the illumination optical system 120. In other words, the illumination optical system 120 and the projection optical system 300 are arranged in a co-axial relationship.

The illumination optical system 120 forms an illuminated area on the first illuminated surface 164, and the illuminated area has an approximately similar figure to the off-axis effective imaging area ARC and the optical axis OO′ shown in FGI. 2. Then, the light illuminates the reticle 200 after passing through the slit 166 and the masking imaging system 170. The second condenser lens 162 uses uniformly illuminates the reticle through Koehler illumination.

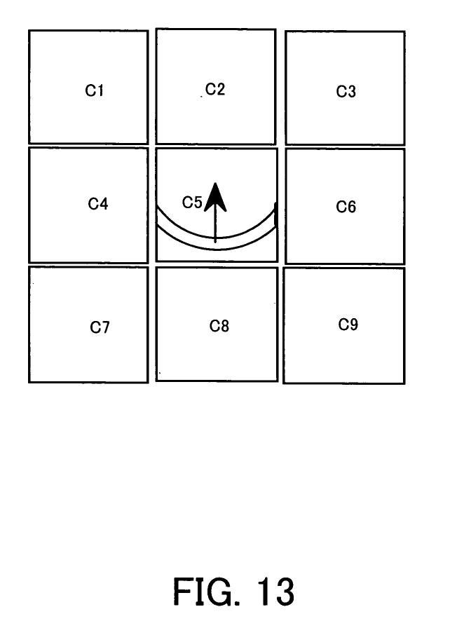

The light that has passed through the reticle 200 is projected onto the plate 400 at a predetermined reduction ratio by the projection optical system 300. The projection optical system 300 forms the arc pattern transfer area ARC on the plate 400 as shown in FIG. 2, and scans the plate 400 in the arc width direction by the synchronous scanning of the reticle 200 and the plate 400, exposing the entire shot (C5 in FIG. 13). Then, a stage for the plate 400 is stepped to the next shot, and many shots (C1 to C9) are exposed and transferred on the plate 400.

The plate 400 is a wafer in this embodiment, but it may include a liquid crystal plate and a wide range of other objects to be exposed. Photoresist is applied onto the plate 400. A photoresist application step includes a pretreatment, an adhesion accelerator application treatment, a photo-resist application treatment, and a pre-bake treatment. The pretreatment includes cleaning, drying, etc. The adhesion accelerator application treatment is a surface reforming process so as to enhance the adhesion between the photo resist and a base (i.e., a process to increase the hydrophobicity by applying a surface active agent), through a coat or vaporous process using an organic film such as HMDS (Hexamethyl-disilazane). The pre-bake treatment is a baking (or burning) step, softer than that after development, which removes the solvent.

The plate 400 is supported by a wafer stage (not shown). The wafer stage may use any structure known in the art, and thus a detailed description thereof will be omitted. For example, the wafer stage uses a linear motor to move the plate 400 in a direction orthogonal to the optical axis. The reticle 200 and the plate 400 are, for example, scanned synchronously, and the positions of the mask stage and wafer stage are monitored, for example, by a laser interferometer and the like, so that both are driven at a constant speed ratio. The wafer stage is installed on a stage stool supported on the floor and the like, for example, via a damper.

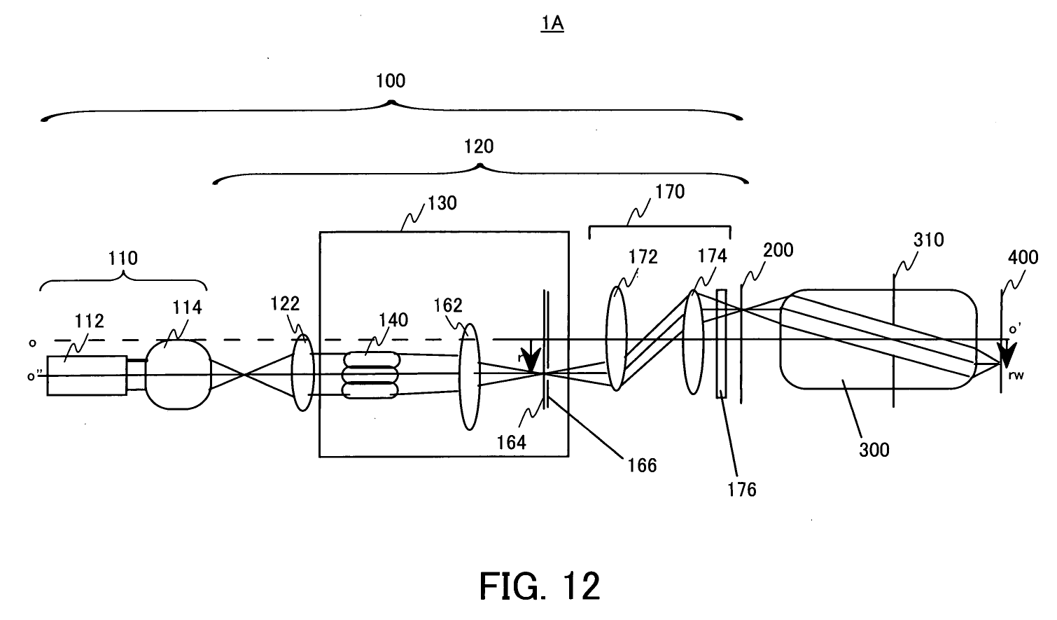

A description will now be given of an exposure apparatus 1A as a variation of the exposure apparatus shown in FIG. 1. Here, FIG. 12 shows a simplified optical path of the exposure apparatus 1A. The exposure apparatus 1A is different from the exposure apparatus 1 in that the optical axis from the light source part 110 to the second condenser lens 162 is offset by r from the optical axis of the projection optical system 300. In the exposure apparatus 1, as shown in FIG. 3, the fly-eye lens 140 does not have to form an arc illumination area at an off-axis portion. Therefore, each of the incident and exit elements is cut and layered in the same manner as shown in FIGS. 7, 8 and 9, sharing the component.

The instant embodiment can transmit the light from the light source for forming the arc or rectangular illumination to the wafer without a loss, improves the light use efficiency, and obtains high light intensity, while economizing the power of the light source.

The above description mainly addresses operations of the present invention about the arc illuminated area. However, the present invention is not limited to the arc illumination, and is applicable to the projection optical system that has an on-axis or off-axis rectangular imaging area, as described later. In this case, in order for a final fly-eye lens to from the rectangular illuminated area, a sectional shape of each lens element should be shaped to a similar figure to the illuminated area on the final image plane.

FIG. 16 shows a simplified optical path of the illumination apparatus 100A as another-variation of the illumination apparatus 100. The illumination apparatus 100A includes a light source part 110, and an illumination optical system 120A. The illumination optical system 120A has a so-called double integrator structure that includes two fly-eye lenses 140 and 180.

The fly-eye lenses 140 and 180 serve to uniformly illuminate the target surface, and are wave front splitting type optical integrators that split the wave front of incident light and form multiple light sources on or near a light exit surface. The fly-eye lenses 140 and 180 convert an angular distribution of the incident light into a positional distribution in emitting the light. The respective light incident surfaces 140a and 180a and the light exit surfaces 140b and 180b of the fly-eye lenses 140 and 140 are in a Fourier transformation relationship. Thus, secondary light sources are formed near the light exit surfaces 140b and 180b of the fly-eye lenses 140 and 180.

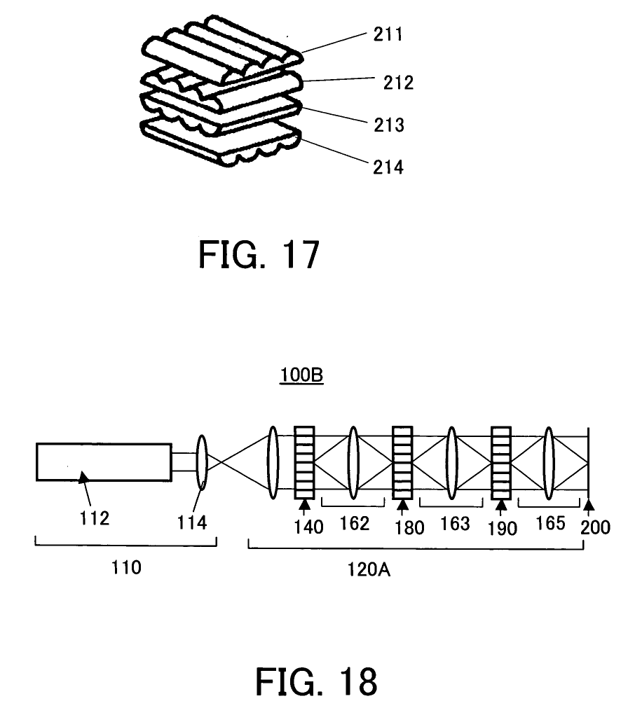

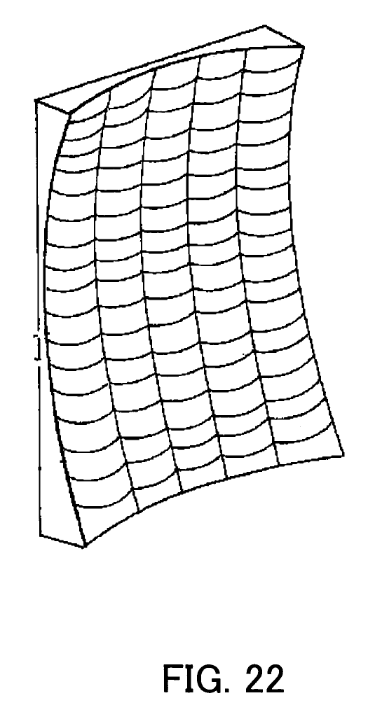

While the fly-eye lenses 140 and 180 include a combination of many rod lenses (or fine lens elements) in this embodiment, the wave front splitting type optical integrator applicable to this invention is not limited to a fly-eye lens but may be, for example, as shown in FIG. 17, multiple sets of cylindrical lens array plates in which respective sets are arranged orthogonal to each other. A fly-eye lens having a rod lens with three or more refracting interfaces may also be used. The light integrator may be a mirror type integrator that has been coated. The mirror type integrator is especially suitable for the EUV light source. The mirror type light integrator having plural elements each with an arc section can use one disclosed in U.S. Pat. No. 6,195,201 and shown in FIG. 22. FIG. 22 is a view of the mirror type light integrator.

Cylindrical lens array plates shown in FIG. 17 form a lens by layering a pair of convex cylindrical lenses having the same generating line or bus and another pair of convex cylindrical lenses having the same generating line that is orthogonal to the previous one. Thus, the plates are formed by stacking two sets of cylindrical lens array plates or lenticular lenses. The cylindrical lens array plates of the first set 211 and the fourth set 214 in FIG. 17 each have a focal length f1, and the cylindrical lens array plates of the second set 212 and the third set 213 have a focal length f2 different from f1. A cylindrical lens array plate in the same set is arranged at the focal position of its counterpart. Two sets of cylindrical lens array plates are arranged such that mutual bus directions are orthogonal to each other, and create beams that differ in F-number in the orthogonal direction (or lens focal length/effective aperture). Of course, the number of sets is not limited to two. So long as multiple cylindrical lenses that have orthogonal mutual bus directions, the number of cylindrical lenses is not limited.

The fly-eye lens 140 is provided to illuminate the fly-eye lens 180 evenly, while the fly-eye lens 180 is provided to illuminate the reticle 200 evenly.

The rod lens in the fly-eye lens 140 has a rectangular section in this embodiment, while the rod lens of the fly-eye lens 180 has a rectangular or a hexagonal section in this embodiment. Here, the term “section” is a section relative to a surface perpendicular to the optical axis. A shape of the fly-eye lens 140's rod lens corresponds to a shape of a beam passing through the shaping optical system 114, and can create a rectangular angular distribution. The fly-eye lens 180's rod lens has a rectangular shape if the reticle 200 surface has a rectangular shape. If the reticle 200 surface is a circle, it will have a hexagonal shape since it is more effective to produce a circle from a hexagon than from a square.

In this case, a ratio of the width to the height in the rectangular lens element in the fly-eye lens 180 is preferably between 2.0 and 18.0, more preferably between 3.0 and 10.0. A ratio of the width to the height in the element in the fly-eye lens 140 is, for example, between 1.0 and 5.0, smaller than that of the fly-eye lens 180. The reason for these values is, similar to the arc case, an enhancement of reduction of shielding and convenience of the aberrational corrections.

The light incident surface 140a of the rod lens in the fly-eye lens 140 and light incident surface 180a of the fly-eye lens 180 are approximately conjugate. This will prevent a loss of a light amount and lowered throughput due to blurring.

If necessary, a stop (not shown) is provided near the exit surface 180b of the fly-eye lens 180. The stop is a variable aperture stop that shields unnecessary light to form a desired shape of a secondary light source, and various stops are available such as a circular aperture stop and a stop for annular, illumination. A modified illumination is available with an aperture stops that has an annular or quadrupole opening. The modified illumination method or oblique incidence illumination method that uses such an aperture stop can extend the limits of the resolving power. The replacement of the variable aperture stop may use, for example, a disc turret that forms these aperture stops, and a controller and a drive mechanism (not shown) turns the turret to switch the opening. Such an aperture stop can vary an illumination mode.

The lens system 162 may include a zooming system to vary a size of the effective light source. When the size of the effective light source varies, a size of the secondary light source changes accordingly. In particular, when the effective light source is made smaller, the secondary light source becomes larger and the fly-eye lens may possibly shield the light. However, this problem is prevented because the instant embodiment sets, as discussed, a ratio of the width to the height in the rectangular lens element in the fly-eye lens 180 in a range between 2.0 and 18.0, more preferably between 3.0 and 10.0. In other words, even when the zooming action of the zooming lens system enlarges the secondary light source, the optical element in the fly-eye lens does not cause a loss of the light in the instant embodiment. This is applied to a case where the condenser lens 122 includes a zooming system in the illumination optical system of the previous embodiment for forming an arc illumination area.

The lens system 162 superimposes the exit light from the fly-eye lens 140 onto the incident surface 180a of the fly-eye lens 180, and uniformly illuminates the fly-eye lens 180. There is no stop between the lens system 162 and the fly-eye lens 180, preventing a loss of the light intensity or lowered throughput. The condenser lens 163 superimposes the exit light from the fly-eye lens 180 onto the reticle 200 surface, and uniformly illuminates the reticle 200 surface.

If necessary, a masking blade (a stop or a slit) for controlling an exposure area being scanned may be provided. Then, the condenser lens 163 condenses as many beams as possible that are wavefront-split by the fly-eye lens 10, and superimposes them with the masking blade, thus Koehler-illuminating the reticle 200 surface uniformly. The masking blade and the light exit surface 180b of the fly-eye lens 180 are arranged in a Fourier transformation relationship, and disposed in a relationship appropriately conjugate with the reticle 200 surface. The exposure apparatus 1 may, if necessary, further include a width-variable slit for eliminating a non-uniform light intensity distribution.

The masking blade has, for example, an almost rectangular aperture when a projection optical system 300 is of a lens type, and has a circular aperture if the optical system 300 is a reflection mirror system of the Offner type. A beam having passed through the aperture in the masking blade is used as an illumination beam for the reticle 200. The masking blade is a stop that has an automatically variable opening width, and can longitudinally change the transfer area (of the opening slit) of the plate 400 described later. The exposure apparatus 1 may further include a scan blade having a structure, similar to the above masking blade for horizontally changing the transfer area of the plate 400. The scan blade is also a stop whose opening width is automatically variable, and is provided at a position optically nearly conjugate with the reticle 200 surface. As a result, the exposure apparatus 1 can use these two variable blades to establish the size of the transfer area in conformity with the size of an exposing shot.

The illumination apparatus 100A of this embodiment provides the high light utilization efficiency on the reticle 200 surface as an illuminated surface, the approximately uniform effective light source distribution, and the approximately uniform light intensity distribution on the reticle 200 surface.

FIG. 18 is a schematic view of a simplified optical path in an illumination apparatus 100B as another variation of the illumination apparatus 100. The illumination apparatus 100B includes a light source part 110, and an illumination optical system 120B, and the illumination optical system 120B includes a triple-integrator configuration that includes three fly-eye lenses 140, 180 and 190.

A sectional shape of the rod lens of the fly-eye lens 190 is set to be rectangular to reduce shielding of the illumination light, since the shape of the reticle 200 surface is typically a rectangle. The condenser lens 165 superimposes the light exiting the fly-eye lens 190 on the reticle 200 surface, illuminating the reticle 200 surface uniformly. A masking blade and the like may be arranged between the condenser lens 190 and the reticle surface. The lens element in the fly-eye lens 180 may have a hexagonal or rectangular shape so as to make circular an effective light source shape having a predetermined illumination condition (such as a coherence factor a) to the fly-eye lens 190. To obtain a circular illuminated area, a hexagon is preferable for light utilization efficiency.

In the optical system in the illumination apparatus 100B, the fly-eye lens 140 prevents any change in the light intensity distribution from the light source from giving any significant impact onto the illuminated surface 200, the fly-eye lens 180 makes the effective light source approximately uniform, and the fly-eye lens 190 makes the light intensity distribution approximately uniform on the reticle 200 surface as the illuminated surface.

The projection optical system 300 applicable to FIGS. 16 and 18 is not limited to a catadioptric optical system. The projection optical system 300 may use an optical system solely including a plurality of lens elements, an optical system including a plurality of lens elements and at least one concave mirror, an optical system including a plurality of lens elements and at least one diffractive optical element such as a kinoform, a catoptric optical system, and so on.

A description will now be given of the operation of the exposure apparatus 1. In exposure, light emitted from the light source 112 is reshaped into a desired beam shape by the beam shaping optical system 114, and then enters the fly-eye lens 140 via the lens 122. The fly-eye lens 140 uniformly illuminates the illuminated surface or the fly-eye lens 180 via the lens system 162. The beam having passed the fly-eye lens 180 illuminates the reticle 200 surface via the masking imaging system 170 or the condenser lens 163. The zoom lens system including the lens system 162 can adjust a size of the effective light source.

The light that has passed the reticle 200 is projected onto the plate 400 under a predetermined reduction magnification by the imaging operations of the projection optical system 300. The angular distribution of the exposure light on the plate 400 (i.e., the effective light source distribution) becomes approximately uniform. If the exposure apparatus 1 is a stepper, it will fix the light source part and the projection optical system 300, and synchronously scan the reticle 200 and the plate 400, then exposing the entire shot. The wafer stage of the plate 400 is stepped to the next shot, thus exposing and transferring a large number of shots on the plate 400. If the exposure apparatus 1 is a scanner, exposure would be performed with the reticle 200 and the plate 400 in a stationary state.

The above embodiments eliminate or at least reduce light shielding at the fly-eye lenses 140, 180 and 190, and can manufacture devices, such as semiconductor chips, such as LSIs and VLSIs, CCDs, LCDs, magnetic sensors, and thin-film magnetic heads, with high throughput.

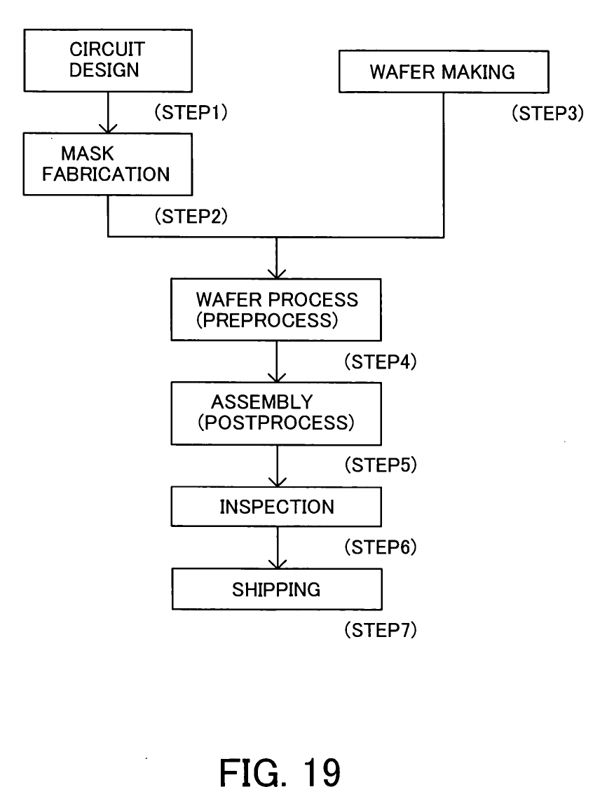

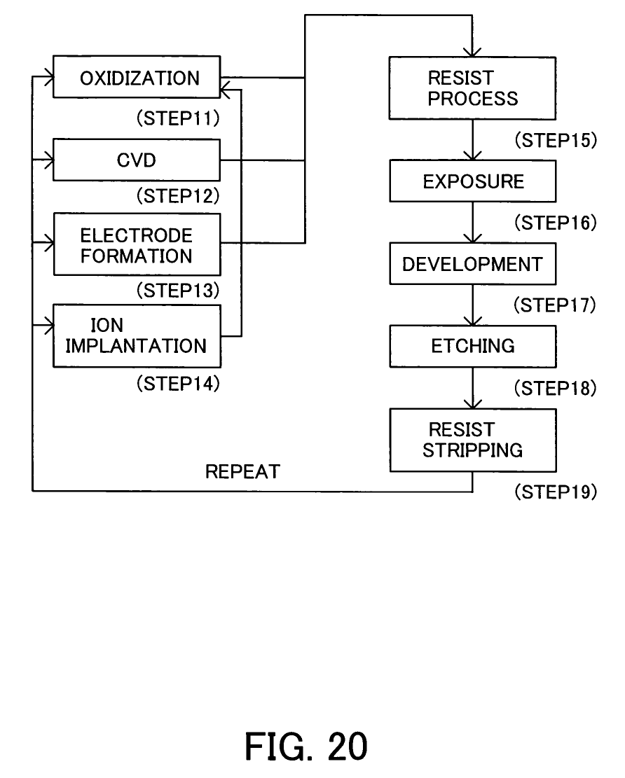

Referring now to FIGS. 19 and 20, a description will be given of an embodiment of a device fabrication method using the above exposure apparatus 1. FIG. 19 is a flowchart for explaining a fabrication of devices (i.e., semiconductor chips such as IC and LSI, LCDs, CCDs, etc.). A description will now be given of a fabrication of a semiconductor chip as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is referred to as a pretreatment, forms actual circuitry on the wafer through photolithography using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 20 is a detailed flowchart of the wafer process in Step 4 in FIG. 19. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ion into the wafer. Step 15 (resist process) applies a photosensitive material onto the wafer.

Step 16 (exposure) uses the exposure apparatus 1 to expose a circuit pattern on the mask onto the wafer. Step 17 (development) develops the exposed wafer. Step 18 (etching) etches parts other than a developed resist image. Step 19 (resist stripping) removes disused resist after etching. These steps are repeated, and multilayer circuit patterns are formed on the wafer. The fabrication method of the instant embodiment makes the effective light source distribution uniform and manufactures high-quality devices with high throughput. In this manner, the device fabricating method that uses the exposure apparatus 1 and the device as a final product constitute one aspect according to the present invention.

Further, the present invention is not limited to these preferred embodiments, but various modifications and variations may be made without departing from the spirit and scope of the present invention.

Thus, the present invention can provide an exposure apparatus that improves a loss of light intensity in a light integrator and lowered throughput.

What is claimed is:

1. An exposure apparatus comprising:
an illumination optical system for illuminating a reticle with light from a light source;
a projection optical system for projecting a pattern of the reticle onto an object to be exposed,
wherein said illumination optical system includes a light integrator that includes plural elements each having an arc section,
wherein a secondary light source formed near an exit surface of the element can be accommodated in the exit surface of the element, and
wherein a ratio of a chord to a width of the arc section of the element is between 2.0 and 18.0.

2. An exposure apparatus according to claim 1, wherein the ratio of the chord to the width of the arc section of the element is between 3.0 and 10.0.

3. An exposure apparatus according to claim 1, wherein the light from the light source has a wavelength smaller than 20 nm, and the ratio of the chord to the width of the arc section of the element is between 4.0 and 18.0.

4. An exposure apparatus according to claim 1, wherein said projection optical system is a catoptric or catadioptric system.

5. An exposure apparatus according to claim 1, wherein an optical axis of said illumination optical system is offset from an optical axis from the light source to the light integrator in said illumination optical system.

6. An exposure apparatus comprising:
an illumination optical system for illuminating a reticle with light from a light source;
a projection optical system for projecting a pattern of the reticle onto an object to be exposed,
wherein said illumination optical system includes:
a first light integrator; and
a second light integrator that includes plural elements, and forms a secondary light source using light from the first light integrator,
wherein the secondary light source that is formed near an exit surface of the element can be accommodated in the exit surface of the element, and
wherein the element has a rectangular section having a ratio of a width to a height between 2.0 and 18.0.

7. An exposure apparatus according to claim 6, wherein the ratio of the width to the height of the rectangular section is between 3.0 and 10.0.

8. An exposure apparatus according to claim 6, wherein said projection optical system is a catoptric or catadioptric system.

9. An exposure apparatus according to claim 6, wherein an optical axis of said illumination optical system is offset from an optical axis from the light source to the first light integrator in said illumination optical system.

10. An exposure apparatus comprising:
an illumination optical system for illuminating a reticle with light from a light source;
a projection optical system for projecting a pattern of the reticle onto an object to be exposed,
wherein said illumination optical system includes:
a first light integrator that includes plural elements; and
a zooming system for adjusting expanse of the light incident upon the first light integrator, and
wherein the secondary light source that is formed near an exit surface of the element can be accommodated in the exit surface of the element, even when the size of the secondary light source varies as the expanse is adjusted.

11. An exposure apparatus according to claim 10, wherein the element has a rectangular section.

12. An exposure apparatus according to claim 10, wherein the element has an arc section.

13. An exposure apparatus according to claim 10, wherein the light from the light source has a wavelength smaller than 20 nm.

14. An exposure apparatus according to claim 10, further comprising a second light integrator that includes plural elements for uniformly illuminating the first light integrator.

15. An exposure apparatus according to claim 10, wherein said projection optical system is a catoptric or catadioptric system.

16. An exposure apparatus according to claim 10, wherein an optical axis of said illumination optical system is offset from an optical axis from the light source to the first light integrator in said illumination optical system.

17. A device fabrication method comprising the steps of:
exposing an object using an exposure apparatus; and
developing the object that has been exposed, wherein said exposure apparatus includes an illumination optical system for illuminating a reticle with light from a light source, a projection optical system for projecting a pattern of the reticle onto an object to be exposed, wherein said illumination optical system includes a light integrator that includes plural elements each having an arc section, wherein a secondary light source formed near an exit surface of the element can be accommodated in the exit surface of the element, and wherein a ratio of a chord to a width of the arc section of the element is between 2.0 and 18.0.

18. A device fabrication method comprising the steps of:
exposing an object using an exposure apparatus; and
developing the object that has been exposed, wherein said exposure apparatus includes an illumination optical system for illuminating a reticle with light from a light source, a projection optical system for projecting a pattern of the reticle onto an object to be exposed, wherein said illumination optical system includes a first light integrator, and a second light integrator that includes plural elements, and forms a secondary light source using light from the first light integrator, wherein the secondary light source that is formed near an exit surface of the element can be accommodated in the exit surface of the element, and wherein the element has a rectangular section having a ratio of a width to a height between 2.0 and 18.0.

19. A device fabrication method comprising the steps of:
exposing an object using an exposure apparatus; and
developing the object that has been exposed, wherein said exposure apparatus includes an illumination optical system for illuminating a reticle with light from a light source, a projection optical system for projecting a pattern of the reticle onto an object to be exposed, wherein said illumination optical system includes a first light integrator that includes plural elements, and a zooming system for adjusting expanse of the light incident upon the first light integrator, and wherein the secondary light source that is formed near an exit surface of the element can be accommodated in the exit surface of the element, even when the size of the secondary light source varies as the expanse is adjusted.
